(19) United States
(12) Patent Application Publication
(10) Pub. No.: US 2023/0354773 A1
(43) Pub. Date: Nov. 9, 2023

(54) PORTABLE PET FOOD CONTAINER

(71) Applicant: Voila Pooch, Irvine, CA (US)

(72) Inventors: Hoyt Yang, Tustin, CA (US); Steven Hsing-Chang Kuo, Taichung (TW)

(21) Appl. No.: 17/662,522

(22) Filed: May 9, 2022

(51) Int. Cl. A01K 5/01; A45C 7/00; A45C 13/00

(52) U.S. Cl. CPC A01K 5/0114; A45C 7/0063; A45C 13/008

(57) ABSTRACT

Embodiments include a portable pet food container comprising a main body having a flexible top end, a flat bottom end, and an internal compartment extending between the top end and the bottom end for storing pet food. The top end comprises a spring-assisted fastener configured to snap open when moved to a first position and snap closed when moved to a second position. The spring-assisted fastener may include a pair of flexible bands and a pair of flex springs, each band having a first end coupled to a first one of the springs and a second end coupled to a second one of the springs, the fastener moving to the first position by pulling the two bands away from each other and moving to the second position by pressing the two bands towards each other. The container may be attached to a wearable device to facilitate portability.

### TECHNICAL FIELD

The present invention relates to a food container and more specifically, a portable container for holding pet food, including solids and liquids.

### BACKGROUND

Pets, such as dogs, are typically fed using bowls or other feeding devices that are placed on the floor or ground for easy access by the pet. Separate dishes or compartments are normally used to provide water and solid food. While they may be suitable for providing pet foods at home, such feeding devices are typically too heavy, bulky, or otherwise inconvenient for carrying and using while traveling or taking pets on a long walk, hike, or other outdoor activity.

While portable pet food containers are available, they are lacking in many respects, including, for example, convenience, ease of use, and maintenance. For example, one pet food container (or “treat pouch”) is designed to be wearable by a user for portability during outdoor activities, but is not water-tight or otherwise usable for feeding water to the pet. As a result, the user (e.g., pet owner or trainer) must carry a second container (e.g., bowl) for water when using this pet food container. As another example, some existing pet food containers are light-weight enough to carry but have an open top with no cover or lid for securing the treats, or water, within the container during transport.

### SUMMARY

A portable pet food container is provided herein to solve the above-mentioned problems, for example, by enabling a user to store and carry pet food (solid or liquid) in the container and convert the same container to a bowl for feeding the food to an animal. In particular, a top of the portable pet food container includes a spring-assisted closure that enables the container to be securely closed to maintain the freshness of the food, and allow for transportation of the food during travel and other activities (e.g., walks, hikes, etc.). The spring closure also enables the container to be easily opened by the user for emptying, filling, or otherwise accessing the contents of the container and securely stay open so that the animal can feed (e.g., eat or drink) directly from the container. In addition, the spring closure enables the container to be easily closed once access is no longer needed, and stay closed to keep the contents fresh and to prevent unwanted access (e.g., when training an animal). The top of the container is also configured to form an opening that is sized and shaped wide enough to receive a mouth (e.g., muzzle, snout, beak, etc.) of the animal during feeding, as well as the user's hand when grabbing the pet food (e.g., treats) for distribution. The portable pet food container is further provided with a wearable mechanism that enables the user to securely attach the container to the user's body for hands-free transport of the container, and to easily remove the container from the user's body and place it on the ground for use as a feeding bowl. The portable pet food container is also configured to have a lightweight, soft shape that rests easily and comfortably against the user's body during transport and has a flat bottom that enables the container to stand upright when placed on the floor or ground for use as a feeding bowl for solid foods and/or a drinking bowl for water. These and other features described herein provide a portable food container that is convertible between a treat pouch and drinking bowl.

While certain features and embodiments are referenced above, these and other features and embodiments of the present invention will be, or will become, apparent to one having ordinary skill in the art upon examination of the following figures and detailed description. It is intended that all such additional embodiments and features included within this description, be within the scope of the present invention, and be protected by the accompanying claims.

### BRIEF DESCRIPTION OF THE DRAWINGS

The present invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a front view of an exemplary portable pet food container attached to a strap, in accordance with embodiments.

FIG. 2 is a rear view of the pet food container of FIG. 1 with the strap partially shown, in accordance with embodiments.

FIG. 3 is a close-up front view of a buckle portion of the strap shown in FIG. 1, in accordance with embodiments.

FIG. 4 is a front perspective view of the pet food container of FIG. 1 with the strap secured to a user, in accordance with embodiments.

FIG. 5 shows the pet food container of FIG. 4 with a top of the container being pulled open by the user, in accordance with embodiments.

FIG. 6 shows the pet food container of FIG. 4 with the top in the open position and the user's hand reaching inside, in accordance with embodiments.

FIG. 7 is a top perspective view of the pet food container of FIG. 4 with the top in the open position and a body of the container holding solid food, in accordance with embodiments.

FIG. 8 shows the pet food container of FIG. 4 with the top in the open position, a bottom of the container resting on the ground, and the body of the container being filled with water, in accordance with embodiments.

FIG. 9 shows the pet food container of FIG. 8 with a dog drinking from the container, in accordance with embodiments

FIGS. 10A and 10B are first and second perspective views of a spring-assisted fastener of the pet food container of FIG. 1 in an expanded state, in accordance with embodiments.

FIGS. 11A and 11B are first and second perspective views of the spring-assisted fastener of FIG. 10 in a collapsed state, in accordance with embodiments.

FIG. 12 is an exploded, rear perspective view of the pet food container of FIG. 1, in accordance with embodiments.

FIG. 13 is a front view of a first exemplary portable pet food container, in accordance with embodiments.

FIG. 14 is a front view of a second exemplary portable pet food container, in accordance with embodiments.

FIG. 15 is a front perspective view of another exemplary portable pet food container, in accordance with embodiments.

FIG. 16 is a cross-sectional view of the portable pet food container of FIG. 15, in accordance with embodiments.

FIGS. 17A through 17C are close-up cross-sectional views of the portable pet food container of FIG. 15, in accordance with embodiments.

FIGS. 18A through 18D are perspective, front, top, and side views, respectively, of an exemplary clip for coupling to the pet food container of FIG. 1, in accordance with embodiments.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers or serial numbers in cases where such labeling facilitates a more clear description. Additionally, the drawings set forth herein are not necessarily drawn to scale, and in some instances proportions may have been exaggerated to more clearly depict certain features. Also, some of the drawings include partial views that have select parts removed for the sake of clarity with respect to the depicted portions. As stated above, this specification is intended to be taken as a whole and interpreted in accordance with the principles of the invention as taught herein and understood by one of ordinary skill in the art.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

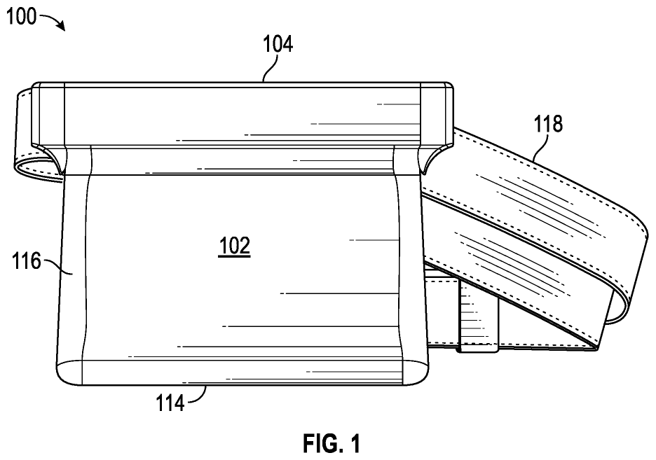

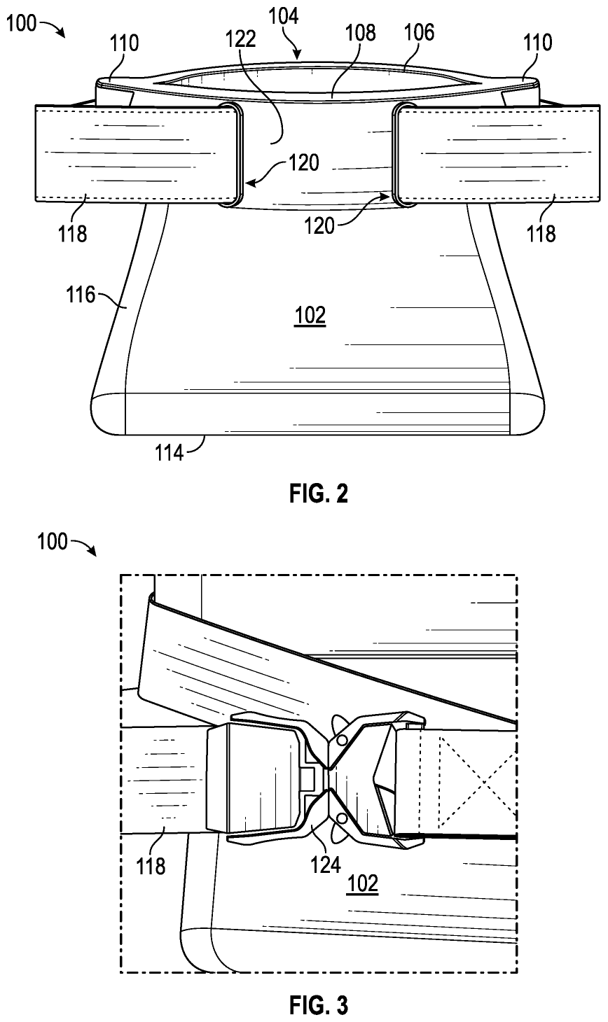

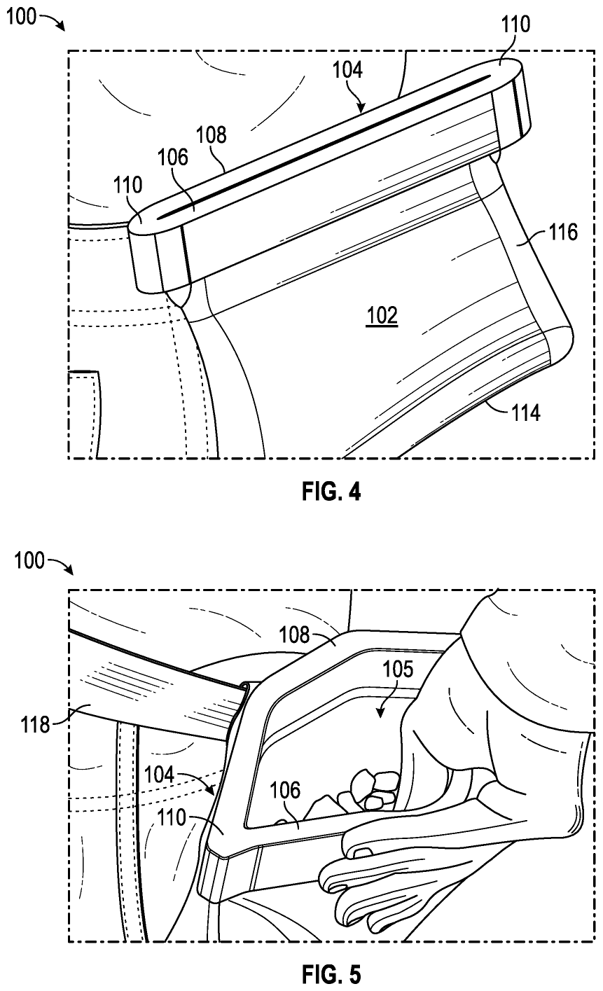

FIGS. 1 through 9 illustrate an exemplary portable pet food container 100 configured to be detachably worn by a user while on the go, and transition between a food carrier and a drinking bowl as needed, in accordance with embodiments. As shown in FIGS. 2 and 4, for example, the container 100 comprises a main body 102 that is configured (e.g., sized and shaped) as a pouch or other vessel with a soft or flexible form. The container's soft form factor enables the container 100 to easily and comfortably rest against the user's body and maintain a low profile when closed. As a result, the container 100 does not hinder movement of the user, obstruct the user's view of the animal, or otherwise get in the way of the user, for example, during long walks or hikes, while training an animal, and more. In addition, the container 100 (also referred to as a “treat pouch”) may be made of lightweight materials to further facilitate portability and wearability. The container 100 is also configured to safely store any type of pet food within the main body 102, including treats or other solid foods, and water or other liquid foods. For example, in embodiments, at least the main body 102 of the container 100 may be made of a food-grade silicone, or any other suitable material that is food-safe and waterproof and/or water-tight.

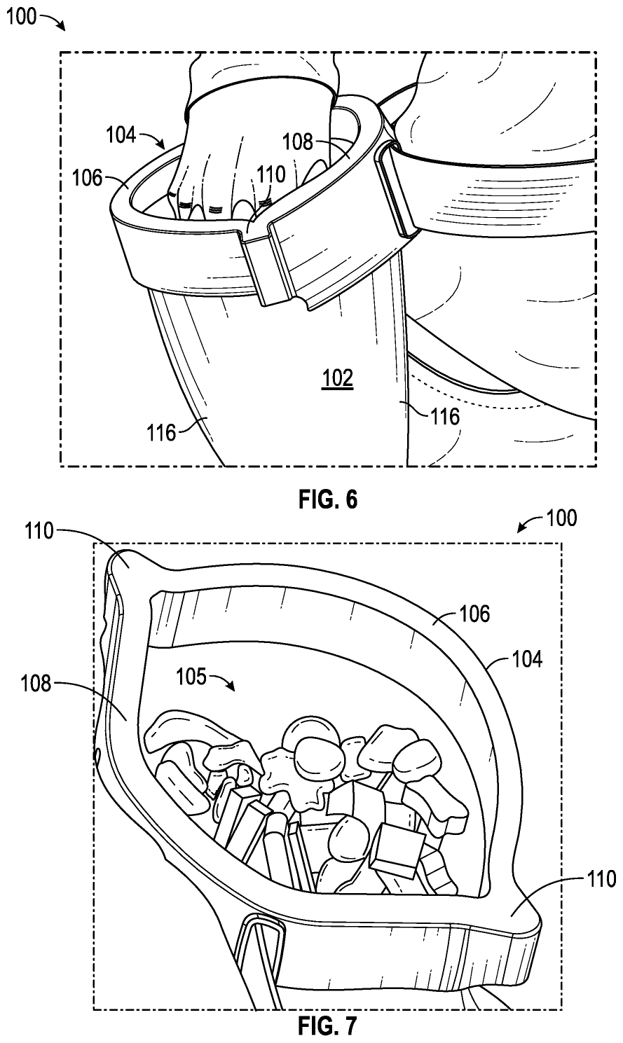

The container 100 further comprises a top end 104 that is movable between an open position (see e.g., FIG. 2) for providing access to an interior compartment 105 of the main body 102 for storing food and a closed position (see e.g., FIG. 4) for sealing the interior compartment 105, and its contents, from outside contaminants. As shown, the top end 104 includes a front wall 106, an opposing back wall 108, and hinged corners 110 for movably coupling opposing ends of the front wall 106 with respective ends of the back wall 108. As shown in FIG. 5, the top end 104 may be opened, or placed in the open position, by moving or pulling the front wall 106 away from the back wall 108, or vice versa, for example, using a hand of the user. Once in the open position, the walls 106 and 108 of the top end 104 are configured to form an opening 112 that is large enough to receive at least a portion of the user's hand, as shown in FIG. 6, or otherwise provide access to treats or other pet food stored in the interior compartment 105 of the main body 102, as shown in FIG. 7. The opening 112 may also be wide and/or large enough to receive a mouth, muzzle, beak, bill, or other animal part used for feeding purposes, as shown in FIG. 9. The top end 104 may be closed, or moved to the closed position, by pressing against the front wall 106 and/or the back wall 108 with a sufficient amount of force, or until the two walls 106 and 108 come together enough to close the opening 112.

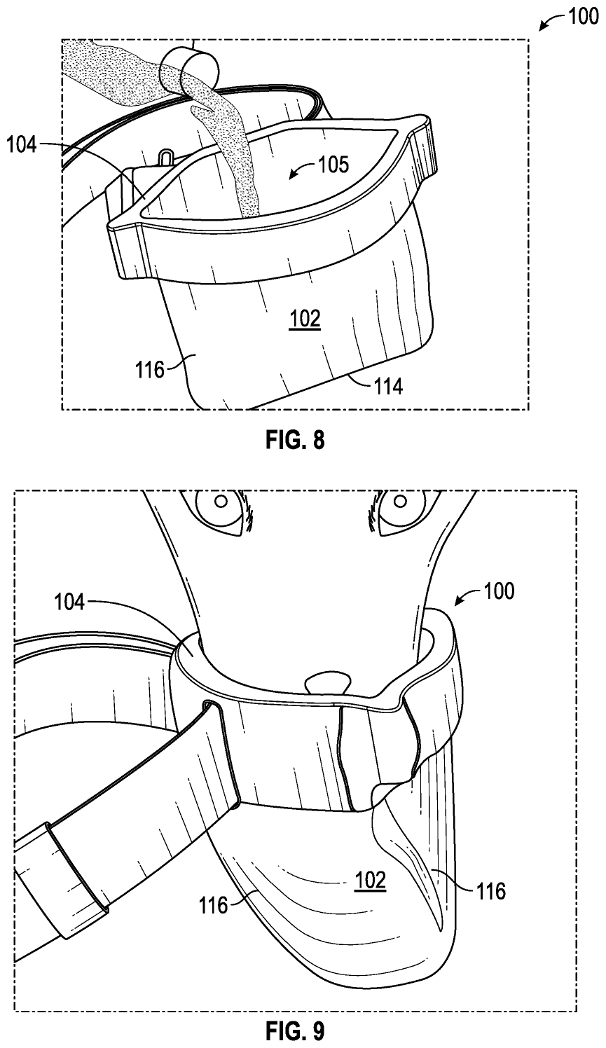

The container 100 also comprises a bottom end 114 configured to provide the container 100 with a substantially flat bottom when the main body 102 is placed on the ground, floor, counter, tabletop, or other surface, for example, for filling the container 100 with water or other food, as shown in FIG. 8, and/or for using the container 100 as a feeding or drinking bowl, as shown in FIG. 9. The bottom end 114 forms part of the main body 102 and may be soft and flexible like the rest of the main body 102. At the same time, at least a portion of the bottom end 114 may be molded or configured to have a substantially flat shape, or otherwise form a substantially flat or planar surface. In embodiments, a width of the bottom end 114 is configured to be wider than the top end 104 when in the closed position, so that the main body 102 has a generally flared shape. This flared shape gives the container 100 increased storage space and makes it easier for the user and animals to access the contents of the container 100. In some embodiments, the width of the bottom end 114 may be selected based on a width of the top end 104 when in the open position, or the opening 112, so as to provide better stability for the container 100 when used for feeding or drinking. Thus, the main body 102 can be configured to help the container 100 stand upright when placed on a surface (e.g., for filling with water), hold more contents, and make it easier to access the contents of the container 100. In addition, the inside corners of the bottom end 114 may be rounded or curved to facilitate retrieval of treats or other foods from the inside corners of the main body 102.

The main body 102 further includes opposing side walls 116 that extend up from the bottom end 114 towards the top end 104. Since the bottom end 114 is wider than the closed top end 104, the side walls 116 create a tapered or triangular side profile for the main body 102 when the top end 104 is in the closed position. For example, the side walls 116 may angle inwards from the bottom end 114 when the top end 104 is closed. When the top end 104 is in the open position, the side walls 116 are pushed outwards and extend substantially vertically, or upwards, between the top end 104 and the bottom end 114. In embodiments, the side walls 116 may be soft and flexible like the rest of the main body 102, but also sturdy enough to support the container 100 in an upright position (e.g., when placed on the ground or other surface), especially when filled with treats or water, for example.

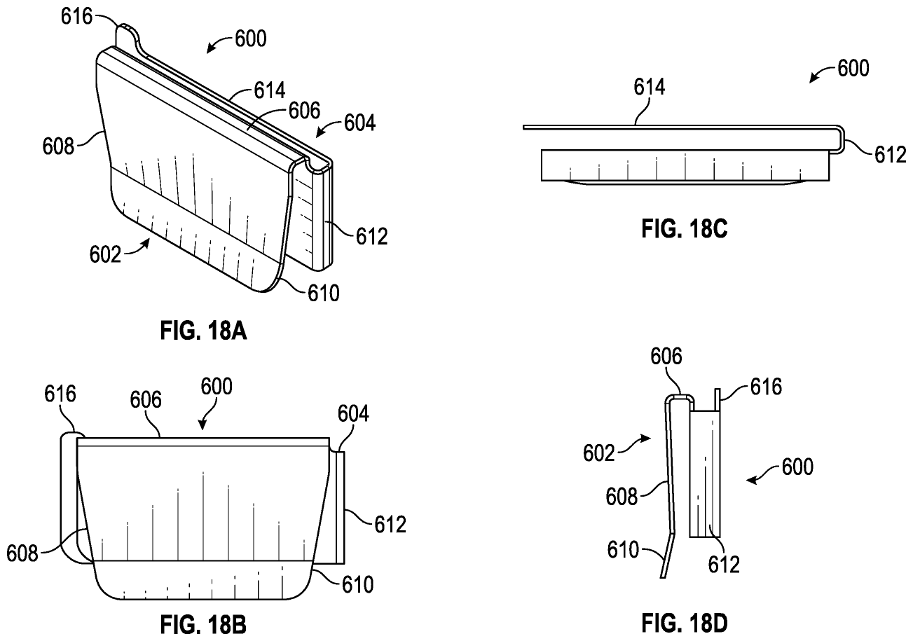

In embodiments, the container 100 is configured to be wearable by the user. For example, the container 100 may be coupled to a belt or other piece of clothing worn by the user (e.g., using clip 600 shown in FIGS. 18A-D) or may be otherwise wearable on the user's body (e.g., like a purse or fanny pack). FIGS. 1 and 2 show the container 100 coupled to a strap 118 (also referred to herein as a “wearable device”) for securing the container 100 to the user, such as, for example, around a waist of the user (e.g., as shown in FIGS. 4 and 5), a chest or torso of the user, or other suitable body part. The strap 118 (also referred to as a “wearable device”) may be adjustable to accommodate different users and/or different attachment locations on the user's body (e.g., waist, chest, etc.). As shown in FIG. 2, the strap 118 is coupled to the container 100 by sliding a free end of the strap 118 through slots 120 that are formed in an outer wall 122 of the top end 104, or more specifically, the back wall 108 of the top end 104, and sized and shaped to receive the strap 118. As shown in FIG. 3, the strap 118 includes a buckle 124 (also referred to as a “fastener”) for securing the two ends of the strap 118 together, for example, after the strap 118 is attached to the user. In other embodiments, the strap 118 may be secured to the container 100 and/or around the user using other suitable attachment means (e.g., Velcro, buttons, magnets, etc.). Other types of wearable devices for securing the container 100 to the user are also contemplated, for example, as shown in FIGS. 18A-D.

According to embodiments, the top end 104 is configured to stay in the open position once the opening 112 is large enough or reaches a first size (e.g., a first distance between the front wall 106 and the back wall 108) and/or the hinged corners 110 are opened wide enough or placed in a first position (e.g., at a first angle between the first wall and the second wall 108). In some embodiments, the top end 104 is also configured to snap closed, or spring back to the closed position, once the walls 106 and 108 are pressed or moved closer together, such that the opening 112 is reduced to a second size (e.g., a second, smaller distance between the front wall 106 and the back wall 108) and/or the hinged corners 110 are narrowed or placed in a second position (e.g., at a second, smaller angle between the front wall 106 and the back wall 108).

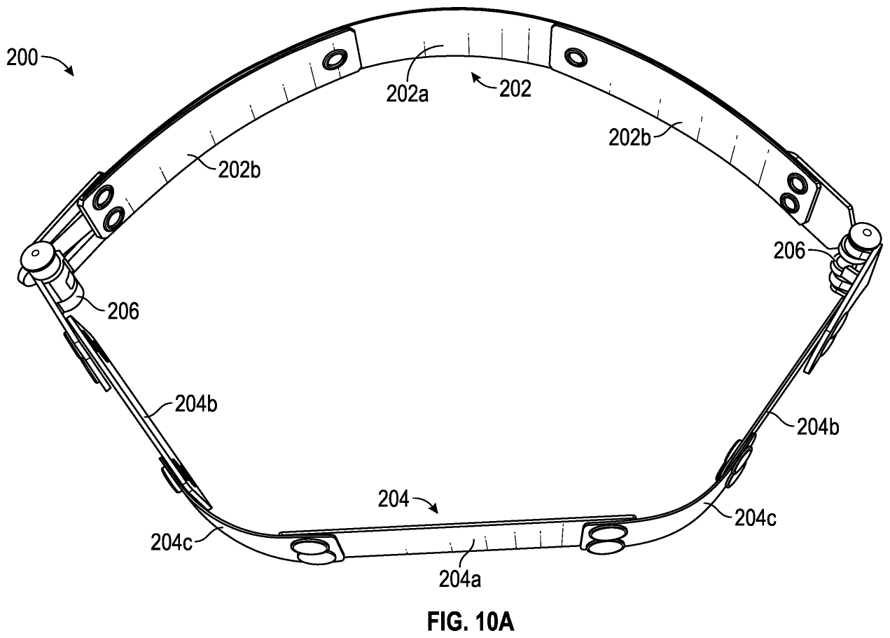

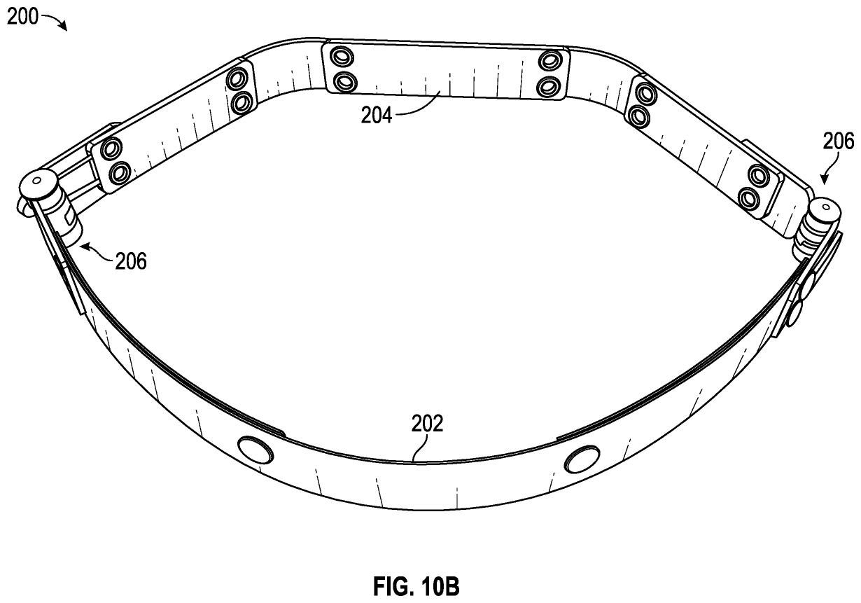

FIGS. 10A-B and 11A-B illustrate an exemplary spring-assisted fastener 200 that may be included in the top end 104 of the main body 102 to enable the container 100 to snap to the open position and stay opened, and snap to the closed position and stay closed, in accordance with embodiments. As shown, the fastener 200 comprises a first wall 202 forming a front side of the fastener 200 and a second, opposing wall 204 forming a back side of the fastener 200. The fastener 200 also comprises a pair of flex springs 206 coupled to respective ends of the first and second walls 202 and 204. More specifically, each of the walls 202 and 204 has a first end coupled to a first one of the springs 206 and a second end coupled to a second one of the springs 206. The fastener 200 (also referred to as a “snap shut metal clip”) may be made of metal (e.g., steel, aluminum, etc.) or any other suitable material that is flexible enough to allow movement of the fastener 200 between an expanded or open state and a collapsed or closed state, but also rigid enough to support the top end 104.

As shown in FIGS. 10A and 10B, when the fastener 200 is in the open state, the first wall 202 is configured to form a curved or rounded shape, while the second wall 204 is configured to form an angular or flat-bottomed shape. For example, in the illustrated embodiment, the first wall 202 comprises a flexible central portion 202a coupled to two side portions 202b that are coupled to respective hinges 206. The central portion 202a bends or curves to give the first wall 202 its rounded shape, while the side portions 202b are substantially flat pieces. The illustrated embodiment also shows that the second wall 204 comprises a substantially flat central portion 204a and a plurality of side portions 204b and 204c that are configured to extend out at an angle from opposite ends of the central portion 204a towards opposite ends of the first wall 202, or the hinges 206 coupled thereto. As shown, a first set of side portions 204b may be substantially flat pieces, while a second set of side portions 204c may be at least slightly flexible or bendable. The flexible side portions 204c are connected between the central portion 204a and each of the first side portions 204b to enable movement of the second wall 204 between the expanded state and the collapsed state.

As shown in FIGS. 11A and 11B, when the fastener 200 is in the closed state, the first and second walls 202 and 204 are configured to collapse or flatten, so that the walls 202 and 204 become substantially flat surfaces that are generally parallel to each other. For example, the flexible second side portions 204c of the second wall 204 may flatten in response to the second wall 204 being pressed closed, thus causing the entire wall 204 to become flat. Similarly, the flexible central portion 202a of the first wall 202 may flatten in response to the first wall 202 being pressed closed.

In other embodiments, the second wall 204 may form a different shape (e.g., rounded, etc.) when the fastener 200 is opened, and/or may be comprised of more or fewer components. Similarly, in other embodiments, the first wall 202 may form a different shape (e.g., angular, etc.) when in the open state and/or may be comprised of more or fewer components. For example, in some embodiments, the first wall 202 and/or the second wall 204 may be a unitary piece configured to flex or bend between the open and closed states.

In various embodiments, the first wall 202 is integrated into the front wall 106 of the top end 104 of the container 100, so that when the fastener 200 is in the open state, the front wall 106 can curve outwards and away from the back wall 108 of the container 100. As shown in FIG. 7, curving the front wall 106 outwards creates a larger opening or space for accessing the container 100 (e.g., for the user's hand, animal's mouth, etc.). Also in embodiments, the second wall 204 is integrated into the back wall 108 of the top end 104 of the container 100, so that the flat central portion 204a is adjacent to the portion of the top end 104 that receives the strap 118 (i.e. the outer wall 122). The flatness of the central portion 204a creates or provides a sturdy connection point between the strap 118 and the top end 104 of the container 100, which helps support or facilitate the motion of pulling the front wall 106 apart from the back wall 108 as the user opens the container 100 (e.g., as shown in FIG. 5).

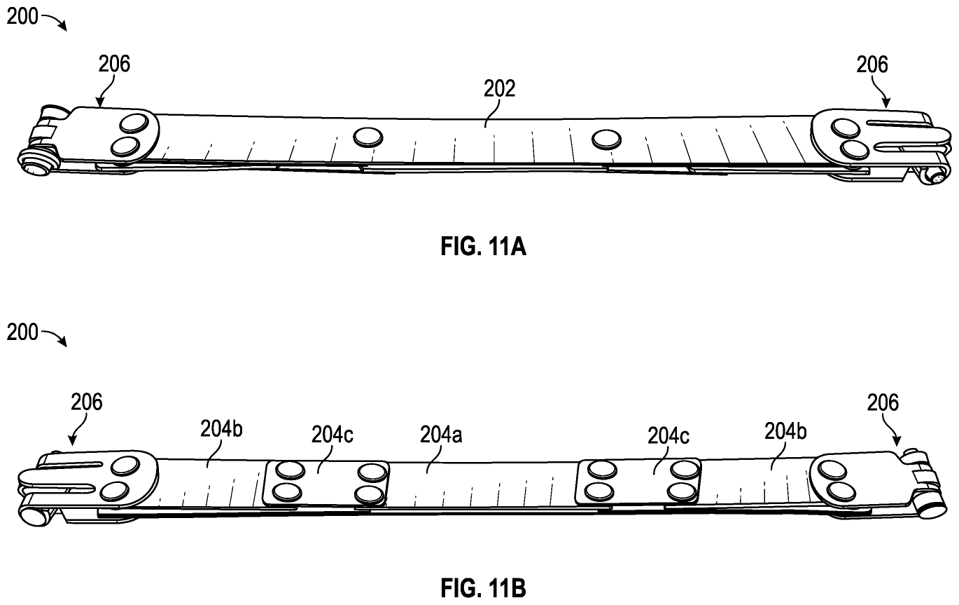

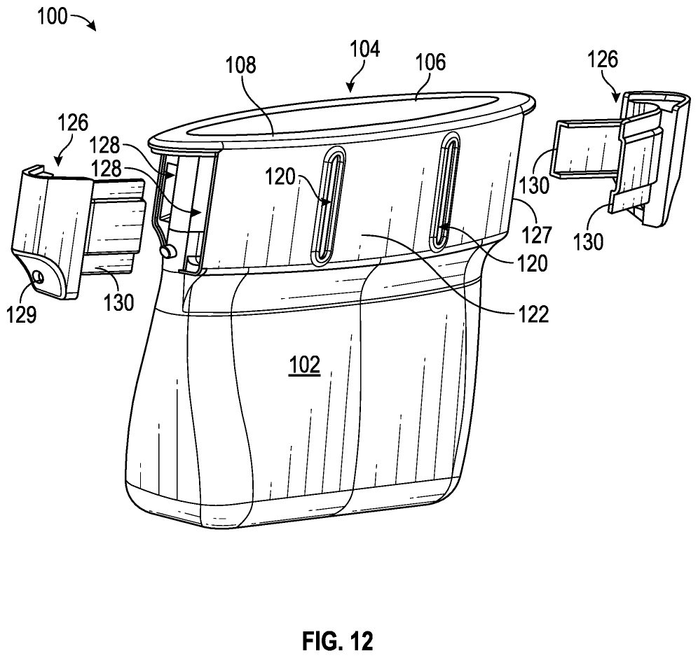

Also in embodiments, the spring-assisted fastener 200 may be coupled to or inserted into the top end 104 of the container 100 such that the flex springs 206 form, or are included within, the hinged corners 110 of the top end 104, in addition to the two fastener walls 202 and 204 forming, or being included within, the front and back walls 106 and 108, respectively, of the top end 104. For example, referring additionally to FIG. 12, shown is an exploded rear view of the pet food container 100 with opposing end pieces 126 removed from a central portion 127 of the top end 104 to show a pair of channels 128 formed within the top end 104 for receiving the spring-assisted fastener 200, in accordance with embodiments. Each of the channels 128 extends through the entire central portion 127 (e.g., from left to right), such that there are openings for accessing the channel 128 on both ends of the central portion 127. The fastener 200 may be coupled to the central portion 127 by passing each of the bands 202 through a respective one of the channels 128, and positioning the flex springs 206 at respective ends of the central portion 127 just outside the channels 128.

In some embodiments, the fastener 200 may be at least partially disassembled before being coupled to the central portion 127 of the top end 104. For example, in some cases, a first one of the springs 206 may be unhinged or removed from the fastener 200, so that the fastener walls 202 and 204 become unattached from each other on one end. In such cases, the free ends of the fastener walls 202 and 204 can be inserted into respective channels 128 using corresponding openings at a first end of the central portion 127, or one of the fastener walls 202 and 204 can be inserted through one of the channels 128, pulled out the other end of the central portion 127, and slid back through the second channel 128. In either case, once the fastener walls 202 and 204 are situated within the channels 128, the first spring 206 may be re-attached to the walls 202 and 204 outside the channels 128. In other embodiments, the fastener 200 may be fully disassembled before being coupled to the top end 104. In such cases, for example, both of the springs 206 may be detached from the fastener walls 202 and 204, and each wall 202, 204 may be inserted into a respective channel 128. Once the fastener walls 202 and 204 are in place within the channels 128, the flex springs 206 may be (re-)attached to respective ends of the walls 202 and 204 outside the channels 128. As will be appreciated, other techniques for coupling the fastener 200 to the container 100 may also be used.

Once the fastener 200 is coupled to the central portion 127, the rest of the top end 104 may be assembled by attaching the end pieces 126 to respective ends of the central portion 127, thus sealing the channels 128 and forming the hinged corners 110 of the top end 104. In some cases, each end piece 126 may be fitted onto and/or over the flex spring 206 that is disposed at the respective end of the central portion 127. In other cases, the end pieces 126 may be coupled to another portion of the central portion 127. As shown, each end piece 126 includes a hole 129 for receiving a lubricant (e.g., oil, etc.) or other substance for lubricating the flex springs 206 of the fastener 200, as needed.

Each end piece 126 may also include a pair of extensions 130 configured for coupling to the openings at each end of the channels 128, for example, using a snap fit or press fit mechanism, or any other attachment technique. In some embodiments, the end pieces 126 may be further attached or secured to the central portion 127 using an adhesive. In such cases, the top end 104 and/or the main body 102 may be heated in order to cure the adhesive and permanently bond the end pieces 126 to the central portion 127, using known techniques. The end pieces 126 may be configured to move along with the spring-assisted fastener 200, or otherwise be flexible enough to allow the fastener 200 to move between the collapsed and expanded states.

Referring back to FIGS. 10A-B and 11A-B, the flex springs 206 are configured to have an amount of tension that is selected to sufficiently enable, or be “just right” for, one-handed operation of the fastener 200 by the user, during both opening and closing, as well as keeping the fastener 200 open during feeding and/or filling. In particular, the flex springs 206 are configured to snap or spring into the expanded state, from the collapsed state, once a first amount of force (e.g., greater than the spring tension) is applied to, or exerted on, the springs 206 in a first direction. As an example, the flex springs 206 may snap open to the expanded state when the user pulls the front wall 106 of the top end 104 away from the back wall 108 of the top end 104 using at least the first amount of force. Likewise, the flex springs 206 are configured to snap or spring back to the collapsed position, from the expanded position, once a second amount of force (e.g., greater than the spring tension) is applied to, or exerted on, the springs 206 in a second, opposing direction. For example, the flex springs 206 may snap closed when the user deliberately pushes or presses the front wall 106 towards the back wall 108 with at least the second amount of force. In addition, the flex springs 206 may be configured to stay closed unless the first amount of force is applied, in order to prevent a pet or other animal from accidentally or improperly accessing food, or “treats,” inside the main body 102 (e.g., while training the pet). The flex springs 206 are also configured to lock into, or stay in, the expanded state, or the collapsed position, until an opposing force (e.g., greater than the spring tension) is applied to the fastener 200, so that the fastener 200 can remain open (and not close shut accidentally) while the pet is eating or drinking out of the container 100. In various embodiments, the second amount of force may be less than the first amount of force such that, for example, only a tap is needed to close the container 100, while a more substantial tug is required to pull the container 100 open.

Referring now to FIGS. 13 and 14, shown are two exemplary sizes for the pet food container described herein. Specifically, FIG. 13 shows a first pet food container 300 having a first or standard size that is, for example, about five inches tall and about eight inches long. FIG. 14 shows a second pet food container 400 having a second or large size that is, for example, about 5.75 inches tall and about eight inches long. Both containers 300 and 400 may be substantially similar to the pet food container 100 shown in FIG. 1 and described herein. For example, both sizes may be configured for wearable use (e.g., attachment to a strap), and both sizes may be configured to convert from a pouch-like food carrier to a flat-bottomed drinking bowl, as described herein. Other sizes for the container 100 are also contemplated, including larger and smaller sizes, as well as other shapes (e.g., depending on the container size).

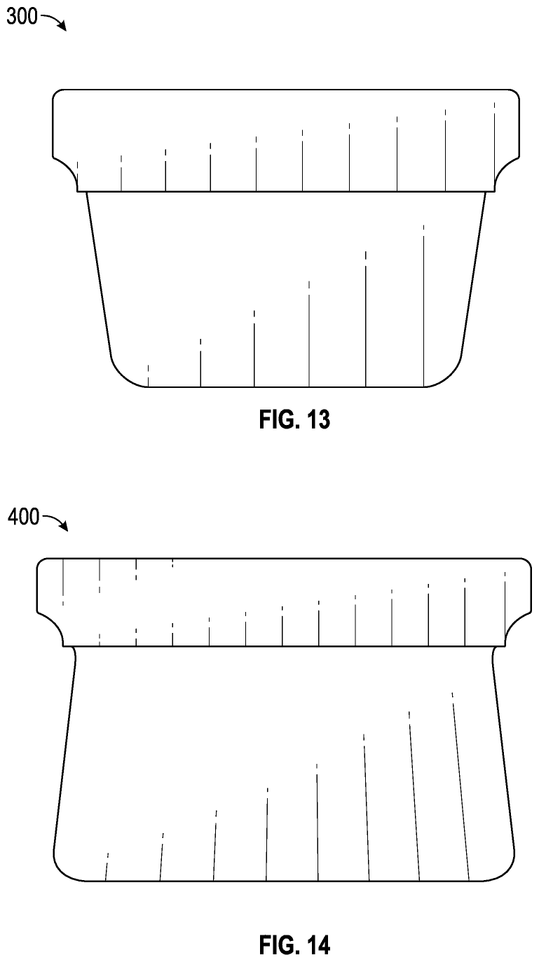

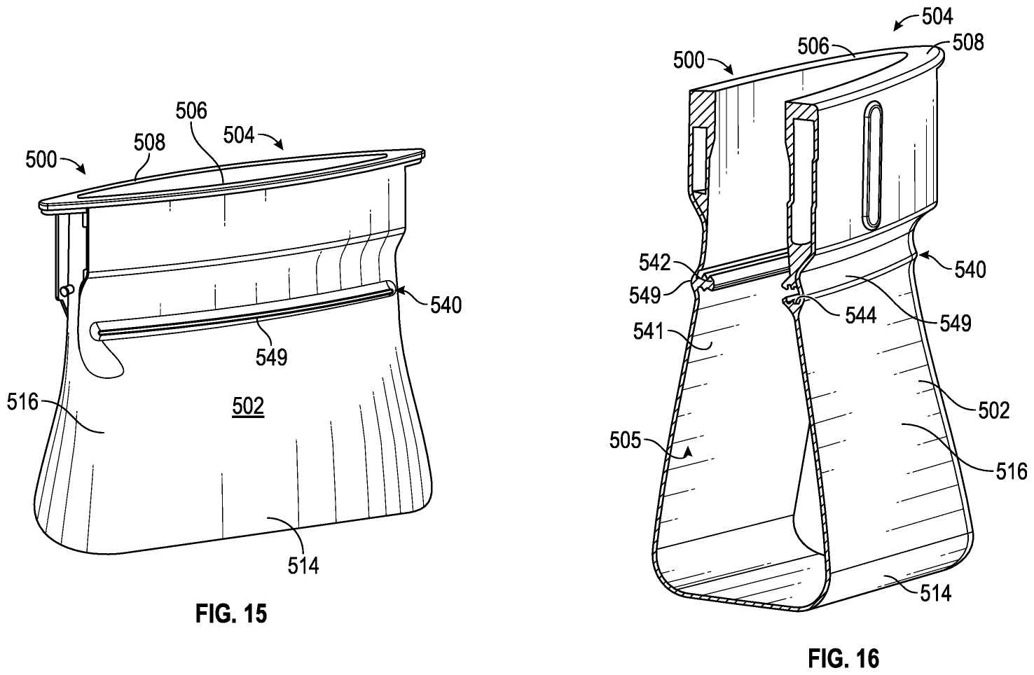

FIGS. 15 and 16 illustrate another exemplary portable pet food container 500, in accordance with embodiments. The container 500 may be substantially similar to the pet food container 100 shown in FIG. 1, except for the addition of a resealable closure 540 for keeping the contents of the container 500 fresh and clear of outside containments. In particular, like the container 100, the container 500 includes a main body 502 with a top end 504, a flat bottom end 514, and flexible sidewalls 516 extending between the two. Also, like the top end 104 of the container 100, the top end 504 includes first and second walls 506 and 508 that are configured to snap open when pulled apart and snap shut when pressed together.

Unlike the container 100, however, the container 500 further comprises the resealable closure 540, which is configured to releasably seal an interior compartment 505 of the main body 502 from air, moisture, debris, and other outside containments. The resealable closure 540 may also be configured to create a water-tight seal, so that water and other liquids can be stored in the container 500 without spilling or leaking out. In various embodiments, the resealable closure 540 is formed within, or coupled to, an interior wall 541 of the interior compartment 502. For example, the resealable closure 540 may be disposed below the top end 504, as shown in FIGS. 15 and 16. Alternatively, the resealable closure 540 may be located within the top end 504, for example, near a top edge of the top end 504. In other embodiments, the resealable closure 540 may be coupled to the container 500 above the top end 504.

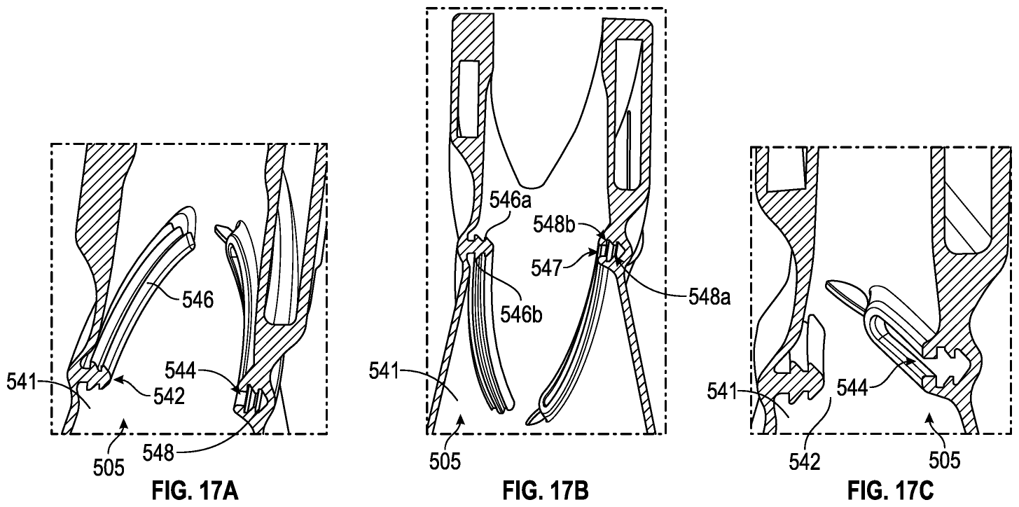

In the illustrated embodiment, the resealable closure 540 comprises a connecting portion or extension 542 configured to extend out from the interior wall 541 and jut into the interior compartment 502. The resealable closure 540 further comprises a receiving portion or slot 544 configured (e.g., sized and shaped) to securely receive the connecting portion 542 therein. The receiving portion 544 (also referred to as a “female member”) may be formed within or from the interior wall 541 and/or may be coupled to a surface of the interior wall 541. Likewise, the connecting portion 542 (also referred to as a “male member”) may be formed from the interior wall 541 and/or may be coupled to the surface of the interior wall 541. As further illustrated in FIGS. 17A through 17C, the connecting portion 542 includes one or more ribs or ridges 546 that extend the length of the connecting portion 542, or across the main body 502. Similarly, the receiving portion 544 includes one or more channels or grooves 548 that extend the length of the receiving portion 544, or across the main body 502. The grooves 548 are configured (e.g., sized and shaped) to receive the ridges 546 once the connecting portion 542 is inserted into, or coupled to, an open end 547 of the receiving portion 544.

As shown in FIGS. 15 and 16, the resealable closure 540 includes first and second outer walls 549 that run along the front and back sides of the container 500, respectively. The outer walls 549 extend or jut out from the main body 502 so as to form a respective rib or channel across each side of the main body 502. In embodiments, the container 500 may be sealed by pinching or pressing together the outer walls 549 of the resealable closure 540, or otherwise applying pressure to both sides of the resealable closure 540 along the outer walls 549. When said pressure is applied while the connecting portion 542 is aligned with and inserted into the open end 547 of the receiving portion 544, the ridges 546 are pushed or forced into the grooves 548 until the connecting portion 542 is fully seated within the receiving portion 544, thus securely coupling the connecting portion 542 to the receiving portion 544. The resealable closure 540 may be opened or released by pulling the two outer walls 549 apart with a sufficient amount of force, or until the connecting portion 542 becomes disengaged from the receiving portion 544.

The ridges 546 may be configured to create an airtight and/or watertight seal once the ridges 546 are engaged with, or locked within, the grooves 548. For example, as shown in FIG. 17B, a first ridge 546a disposed at a front or tip of the connecting portion 542 may be configured (e.g., sized and shaped) to substantially match a size (e.g., height and width) and shape of a first groove 548a disposed at the back of the receiving portion 544 or a distance away from the open end 547, while a second ridge 546b disposed behind the first ridge 546b may be configured to substantially match a size and shape of a second groove 548b disposed at the front of the receiving portion 544 or adjacent the open end 547. In this manner, the internal compartment 505 can be sealed from outside air and other containments, while also keeping the contents of the container 500 securely within the internal compartment 505.

While the illustrated embodiment shows a specific zipper-like sealing mechanism for the resealable closure 540, it should be appreciated that any other type of attachment or sealing mechanism may be used to releasably seal the internal compartment 505.

Referring now to FIGS. 18A-D, shown is another exemplary wearable device for attaching the container 100 to a user's body, in accordance with embodiments. Clip 600 is configured for attachment to the container 100 in place of the strap 118 and further configured for attachment to an item worn by the user. As shown, the clip 600 includes a first attachment mechanism 602 and a second attachment mechanism 604 for enabling these connections. The clip 600 may be made of metal, hard plastic, or any suitable material. While the illustrated embodiment shows a particular shape and size for the clip 600, other configurations of the clip 600 are also contemplated and fall within the scope of this disclosure, including larger or smaller designs, different shaped designs, and different attachment styles.

As best seen in FIGS. 18A and D, the first attachment mechanism 602 comprises a curved top surface 606 and a broad front surface 608 that extends out at an angle from the rest of the clip 600, or the second attachment mechanism 604. A width of the top surface 606 and the angle of the front surface 608 may be configured to create a space between the first attachment mechanism 602 and the second attachment mechanism 604 for receiving, or coupling to, a belt, pant pocket or waistband, bag (e.g., fanny pack, backpack, purse, etc.), or any other item worn by the user. In addition, the top surface 606 may be configured to at least slightly bend or flex in order to allow the front surface 608 to be pulled apart from the rest of the clip 600, as needed, when securing the first attachment mechanism 602 to the user. As shown, a bottom end of the front face 608 may include a lip 610 that angles away from the rest of the clip 600 (e.g., about 15 degrees) to help keep the first attachment mechanism 602 securely in place once attached to the user.

As also shown, the second attachment mechanism 604 includes a curved side surface 612 and a broad back surface 614 that extends parallel to the front surface 608. A width of the side surface 612 and the dimensions of the back surface 614 may be configured for attachment to the container 100 via the slots 120 formed in the outer wall 122 of the top end 104. For example, a length and height of the back surface 614 may be selected based on a length of the outer wall 122 and a height of the slots 120. During installation of the clip 600, the back surface 614 may be slid into a first one of the slots 120 and out the other slot 120. As shown, a free end of the back surface 614 may include one or more extensions 616 configured to extend upwards from the main body of the back surface 614. When installed in the outer wall 120, the extension(s) 616 may be positioned outside the slots 120 to prevent the back surface 614 from slipping out of the slots 120. In some cases, the side surface 612 may be configured to at least slightly bend or flex in order to allow the back surface 614 to be pulled apart from the rest of the clip 600, as needed, when securing the second attachment mechanism 604 to the container 100.

Thus, a portable pet food container configured to transition between a pouch-like carrier and a drinking bowl is provided. Crafted from high-quality, food-grade silicone, this multipurpose container provides a highly efficient and easy-to-clean delivery system that is capable of storing pet food, including water, and prolonging its freshness. The container includes a spring-assisted closure for easy open and close ability (e.g., to provide quick access to treats), and can be attached to a sturdy, adjustable belt or other wearable device for portability. The container also includes a soft flexible body to allow for convenient carrying and a flat-bottom for enabling conversion to a drinking bowl.

It will be understood by those skilled in the art that various changes may be made and equivalents may be substituted without departing from the scope of the novel and non-obvious techniques disclosed in this application. Therefore, it is intended that the novel teachings of the present invention not be limited to the particular embodiment disclosed, but that they will include all embodiments falling within the scope of the appended claims.

What is claimed is:

1. A portable pet food container, comprising:
a main body having a flexible top end, a flat bottom end, and an internal compartment extending between the top end and the bottom end for storing pet food,
wherein the top end comprises a spring-assisted fastener configured to remain open when moved to a first position and remain closed when moved to a second position.

2. The portable pet food container of claim 1, wherein the spring-assisted fastener includes a pair of flexible walls and a pair of flex springs, each wall having a first end coupled to a first one of the springs and a second end coupled to a second one of the springs.

3. The portable pet food container of claim 2, wherein the spring-assisted fastener is moved to the first position by pulling a first of the walls away from a second one of the walls using a first amount of force.

4. The portable pet food container of claim 3, wherein the spring-assisted fastener is moved to the second position by pressing the first one of the walls towards the second one of the walls using a second amount of force.

5. The portable pet food container of claim 4, wherein the second amount of force is less than the first amount of force.

6. The portable pet food container of claim 1, wherein the main body is configured for use as a feeding or drinking vessel while the top end is open.

7. The portable pet food container of claim 1, further comprising a resealable closure configured to releasably seal the internal compartment.

8. The portable pet food container of claim 1, further comprising a wearable device configured for attachment to the main body.

9. The portable pet food container of claim 8, wherein the wearable device is a strap configured for attachment around a waist or torso of the user.

10. The portable pet food container of claim 8, wherein the wearable device is a clip configured for attachment to an item worn by the user.

11. The portable pet food container of claim 1, wherein the main body has a soft, flexible form.

12. The portable pet food container of claim 1, wherein the main body is made of silicone.

13. The portable pet food container of claim 1, wherein the main body has a generally flared shape extending from the top end to the bottom end.
